(19) United States
(12) Patent Application Publication
(10) Pub. No.: US 2024/0400315 A1
(43) Pub. Date: Dec. 5, 2024

(54) METHOD OF LOWERING A STREAM OF BOARDS

(71) Applicant: Automated Industrial Technologies, Inc., Forest, VA (US)

(72) Inventors: David Raymond SCHLUETER, Madison Heights, VA (US); Harold Ryan WOMACK, Lynchburg, VA (US)

(73) Assignee: Automated Industrial Technologies, Inc., Forest, VA (US)

(21) Appl. No.: 18/680,102

(22) Filed: May 31, 2024

Related U.S. Application Data
(60) Provisional application No. 63/470,044, filed on May 31, 2023.

(51) Int. Cl. B65G 47/12

(52) U.S. Cl. CPC B65G 47/12

(57) ABSTRACT

The invention provides an apparatus and method to passively lower a stream of individual boards inline with conveyors or other apparatus between a board feeding mechanism, such as an unscrambler machine, and a board handling mechanism such as a stacking machine in the pallet industry. The apparatus includes multiple ramps for lowering the boards.

### RELATED APPLICATION

This application claims the benefit of U.S. Provisional Application Ser. No. 63/470,044, filed May 31, 2023, entitled “Method Of Lowering A Stream Of Boards,” which is incorporated herein by reference in its entirety.

### FIELD OF THE INVENTION

The present invention provides a mechanism to passively lower a stream of individual boards inline with conveyors or other apparatus between a board feeding mechanism such as an unscrambler machine and a board handling mechanism such as a stacking machine in the pallet industry.

### BACKGROUND OF THE INVENTION

In the lumber industry, wood is processed along its length to reduce the size of the cutting tools required to produce the desired cross-sectional shape. After the processes of shaping and sizing have been completed the resulting boards are transported with the length of board across the conveyance.

The pallet industry takes standard size lumber, converts it into specific board dimensions and feeds the boards into the pallet assembly operation. In the pallet industry, the dimensional lumber is processed into different lengths, widths and thicknesses resulting in multiple boards from one dimensional piece. The production at higher speeds of a specific width and thickness from larger dimension boards for a specific pallet size or other product requirement amplifies the need for high speed, reliable and efficient handling. This need can be addressed with: (a) more people manually handling; (b) faster automated conveying systems; and (c) multiple slower conveying systems splitting the load, or a combination thereof.

In general boards are straightened and singulated individually or in groups by hand or automatically by machine. Machine straightening and singulation is accomplished by lifting one board at a time and carrying them on multiple strands of belt or chain conveyors with lugs to keep the boards straight. It is common to use gravity to keep each board against the multiple lugs that are moving them by making the conveyor run up hill. In general, the faster the conveyors are running, the greater the change in elevation required. The spacing between the boards on the conveyor is determined by the largest width the equipment is designed to handle and the next change of direction or support. It is understood that the more boards per minute that are handled the greater the linear distance required to keep them separated and oriented. The industry has developed methods to accumulate the boards in piles or stacks between the steps in producing dimensional lumber or the components for a pallet. This accumulation reduces the floor space required to handle the individual boards. The result of these accumulation methods resulted in the development of equipment to feed boards out of the piles or stacks automatically. Two examples of feeding boards out of piles are the Automated Industrial Technologies (AIT) unscramblers for the M2L Machine (Up Stacker) and the TS Machine (Down Stacker). The piles of boards are dumped into the Unscrambler (UNX) hopper. On the M2L UNX two or more chains with lugs lift the boards out of the pile and lift them up a 45° to 55° slope. The lugs are dimensioned and/or adjusted to only lift one board thickness at each position, thus lifting only one board at each lug on the chain. At lower board per minute rates the length of the 45° to 55° slope is 2 to 3 feet and the boards can continue back down to a “normal elevation” on the same chain/lugs. The TS UNX Machine has multiple chains with adjustable and variable height lugs that can lift more boards per minute. The slope is the same 45 to 55 degrees but the length is 5 to 6 feet and the boards exit the chains at the top of the slope. All of which allows the TS UNX Machine to run the chains at a faster lugs per minute rate.

The wood processing industry, an example of which is pallet building, has developed to include several standard machine types which allow for a production line to function efficiently. All the board preparation steps run much faster than the finished pallet assembly step. The speed difference and space requirements mean than all the component boards must be accumulated in an orderly arrangement (stacked) so that they can be stored and then efficiently transferred to the final assembly step.

There are three common methods of creating stacks of boards for storage and movement by dolly, forklift or similar means. The first is by picking up individual or groups of boards by hand and creating a stack from the bottom up. The second is by creating a layer of boards and dropping the layer on top of another layer of boards or the initial supporting structure. The third method is to create a layer of boards on a conveyor and lift the layer up to the bottom of a stack or initial supporting structure. Each method has its own capacities and advantages. Generally, the fastest method has become dropping a layer on top because the distance between the new layer and the top of the stack is reduced and the mechanical mechanism requires the least movement. The disadvantage is the loss of control while the layer is dropped even the short distance.

As the industry has improved both the up stacking and down stacking equipment so it will run at higher speeds, the extra elevation required to singulate and orient boards has become a necessity. This means that up stacking equipment requires a controlled method to bring the flow of boards back down to a 32 inch to 42 inch pass line. It is anticipated that the lifting conveyor chains could be extended and the lugs on the chains modified to lower the boards down. However, with a constant lug pitch and variable width boards the extra space between lugs for the widest boards, this allows the front of the boards to surge to the back of the front lug as it starts to fall. The surging requires a much gentler slope of the carrying chains as the boards are lowered increasing the distance the boards travel. At the bottom of the path the board can start to slow, until the original pushing/lifting lug hits the back of the board. At higher speeds the impact accelerates the board forward and causes more of them to skew.

The prior art discloses various apparatus and methods for moving and handling articles. For example, U.S. Pat. No. 9,051,123 discloses two continuous parallel walls to lower articles from one elevation to another but includes no instruction on a method to keep the article singulated or oriented. U.S. Pat. No. 11,827,461 discloses two parallel curved walls to reverse the direction of flow of a pile of rod-like articles while lowering the pile from an upper surface to a lower surface. The shape of the twin curved walls minimizes the height of the pile to eliminate damage to the articles. The illustrations show contact between all members of the pile both in the minimum accumulation case and the maximum multi-level illustration. U.S. Pat. No. 803,944 and U.S. Pat. No. 1,766,681 disclose multilevel ramps, straight and curved, to slow the vertical velocity of flexible bags dropped into the hold of a ship.

### SUMMARY OF THE INVENTION

An object of the present invention is to provide an apparatus and method to passively lower a stream of individual boards inline with conveyors or other apparatus between a board feeding mechanism such as an unscrambler machine and a board handling mechanism such as a stacking machine in the pallet industry.

Another object of the present invention is to provide an apparatus and method to passively lower a stream of individual boards inline with conveyors or other apparatus between a board feeding mechanism, such as an unscrambler machine, and a board handling mechanism, such as a stacking machine, in the pallet industry wherein the apparatus includes multiple ramps for lowering the boards.

The present invention is directed to an apparatus for lowering a stream of boards inline with conveyors or similar equipment comprising a first ramp for receiving a singulated and oriented (S&O) board having an entrance, a slide and a tipping radius, a second ramp adjacent the first ramp and adapted to receive the S&O board from the first ramp having a top shield, a containment radius, a linear slide and a tipping radius, and a third ramp adjacent to the second ramp and adapted to receive the S&O board from the second ramp having a bottom shield, a containment radius, a linear slide and a direction change radius, wherein the S&O board exits the third ramp to a further operation on the S&O board.

The invention is further directed to a method of using the apparatus of the invention.

These primary and other objects of the invention will be apparent from the following description of the preferred embodiments of the invention and from the accompanying drawings.

### BRIEF DESCRIPTION OF THE DRAWINGS

The following detailed description of the specific non-limiting embodiments of the present invention can be best understood when read in conjunction with the following drawings, where like structures are indicated by like reference numbers.

Referring to the drawings:

FIG. 1 shows the apparatus and method of the invention.

FIG. 2 is a side view with frame and takeaway conveyor.

FIG. 3 is a side view of the invention.

FIG. 4 is a downstream view of the invention.

FIG. 5 is an upstream view of the invention.

FIG. 6 is a top view of the invention.

### DETAILED DESCRIPTION OF THE INVENTION

The present invention is directed to a passive system using multiple ramps to provide a path to lower singulated and oriented boards by gravity at high speed to an elevation suitable for creating stacks of lumber from the bottom up. It is important to maintain the spacing between boards in order that they do not stack or shingle on each other as they are lowered on the ramp system. The system requires a minimum horizontal distance of travel to move between the two elevations.

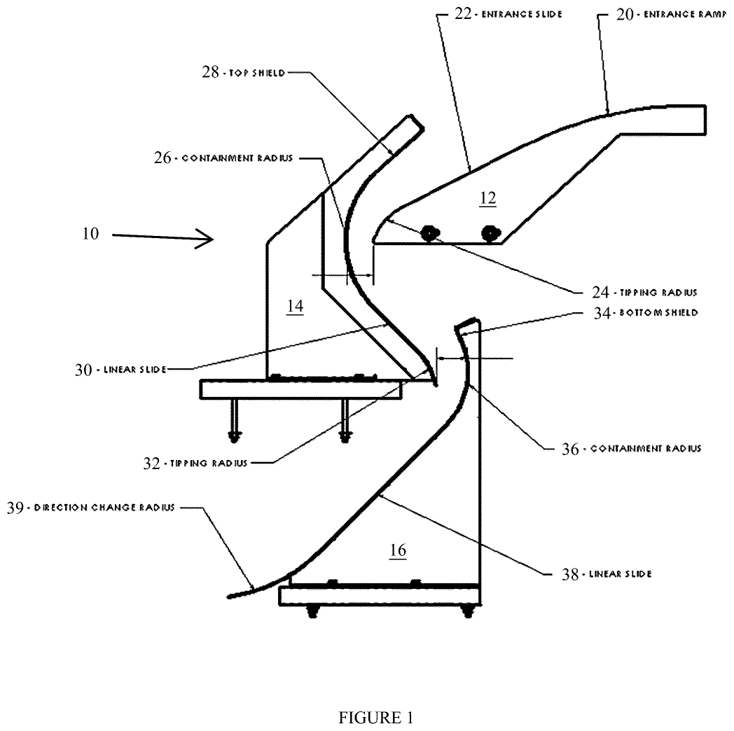

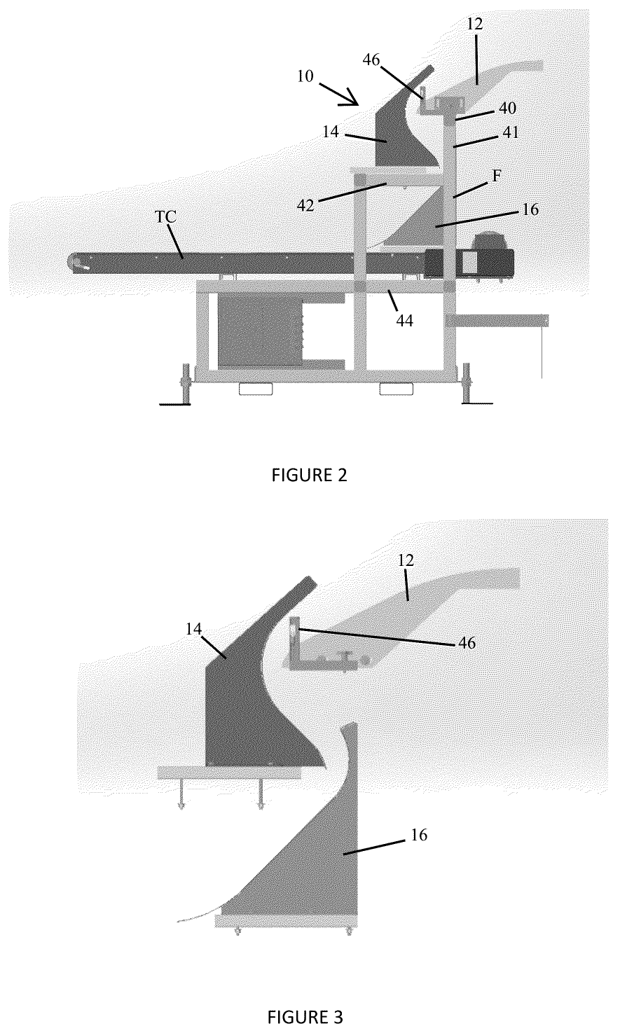

The invention provides for a ramp system 10 having multiple ramps 12, 14 and 16, combined into a single fabricated structure as shown, for example, in FIG. 1. FIG. 2 shows the invention of FIG. 1 integrated with a frame F and a takeaway conveyor TC for receiving the singulated and oriented boards for subsequent stacking.

Referring to the Figures, the ramp 12 includes an entrance 20 connected to the high-speed conveyance of the boards that have been S&O with the long dimension perpendicular to the direction of travel (not shown). The ramp 12 declines slightly to maintain the linear velocity of the entering boards. Ramp 12 includes an entrance slide 22 providing the vertical component of the acceleration due to gravity to the initial board velocity to overcome any sliding friction and maintain spacing. Ramp 12 includes a tipping radius 24 which allows the width of the board to become vertical after passing its center of gravity and dropping down to ramp 14. There is a board containment radius 26 which corrects any skewing of the board and reverses the direction of travel. Ramp 14 further includes a top shield 28 overlying ramp 12 and middle linear slide 30 which settles the board and passes it on to tipping radius 32 which again allows the width of the board to become vertical and drop to ramp 16. Ramp 16 includes a bottom shield 34 overlying the bottom of ramp 14 and a board containment radius 36 to correct any skewing of the board and reverses the direction of travel of the board. There is a bottom linear slide 38 which settles the board and passes it along the slide 34 and which adjusts the change in elevation before the discharge of the S&O board at termination radius 39 and the entrance to the next operation. The termination radius 39 provides a direction change radius which transitions the width of the board from approximately a 45 degree angle to parallel with the next pass line.

This method and apparatus example has lowered the pass line of the board stream by approximately 44 inches in an approximate distance of 44 inches. At the same time keeping the length of the boards perpendicular to the direction of travel and maintaining or increasing the space between boards.

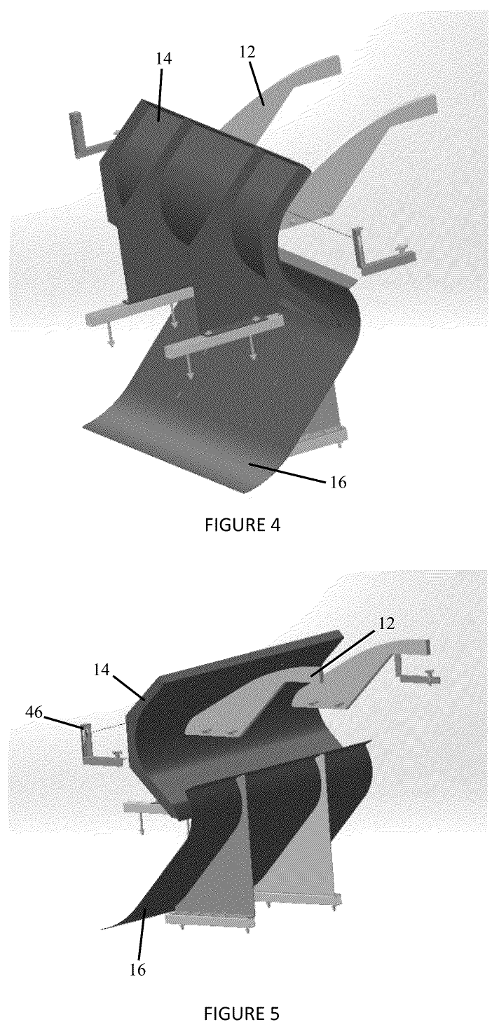

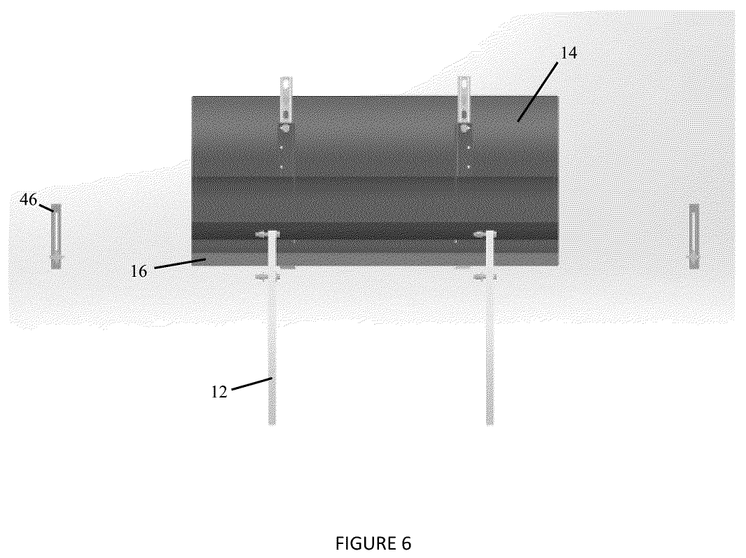

Referring to FIGS. 2-5, the ramp system 10 is shown integrated into a frame wherein ramp 12 (two pieces) is connected to a horizontal post 40 attached to a vertical post 41; ramp 14 is attached to horizontal post 42 as shown in FIG. 4; and ramp 16 is connected to horizontal post 44 as shown in FIG. 5 which ties into takeaway conveyor TC. There is a sensor 46 for detecting the S&O boards.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claim.

1. An apparatus for lowering a stream of boards inline with a conveyor or similar equipment comprising a first ramp for receiving a singulated and oriented (S&O) board having an entrance, a slide and a tipping radius, a second ramp adjacent the first ramp and adapted to receive the S&O board from the first ramp having a containment radius, a linear slide and a tipping radius, and a third ramp adjacent to the second ramp and adapted to receive the S&O board from the second ramp having a containment radius, a linear slide and a direction change radius, wherein the S&O board exits the third ramp to a further operation on the S&O board.

2. The apparatus of claim 1 wherein the second ramp includes a top shield and the third ramp includes a bottom shield.

3. The apparatus of claim 1 wherein the stream of boards are boards for assembling a pallet.

4. The apparatus of claim 1 wherein the third ramp exits to a conveyor moving the boards to a board stacking machine.

5. The apparatus of claim 1 wherein the inline conveyor is downstream from a board unscrambling machine.

6. A method for lowering a stream of boards comprising the steps of
a. providing a board feeding apparatus which singulates and orients (S&O) a plurality of boards;
b. moving the S&O boards on a first conveyor to an apparatus for lowering the S&O boards;
c. lowering the S&O boards on the board lowering apparatus wherein the board lowering apparatus comprises a first ramp for receiving the S&O boards having an entrance, a slide and a tipping radius, a second ramp adjacent the first ramp and adapted to receive the S&O boards from the first ramp having a containment radius, a linear slide and a tipping radius, and a third ramp adjacent to the second ramp and adapted to receive the S&O boards from the second ramp having a containment radius, a linear slide and a direction change radius, wherein the S&O boards exit the third ramp to a second conveyor; and
d. moving the S&O boards on the second conveyor to a board handling machine.

7. The method of claim 6 wherein the second ramp includes a top shield and the third ramp includes a bottom shield.

8. The method of claim 7 wherein the stream of boards are boards for assembling a pallet.

9. The method of claim 6 wherein the board feeding apparatus comprises a board unscrambling apparatus.
